(19) United States
(12) Patent Application Publication
(10) Pub. No.: US 2020/0360874 A1
(43) Pub. Date: Nov. 19, 2020

(54) FROTHING DEVICE

(71) Applicant: Dominic Symons, Singapore (SG)

(72) Inventor: Dominic Symons, Singapore (SG)

(21) Appl. No.: 16/410,521

(22) Filed: May 13, 2019

(51) Int. Cl. B01F 3/04; B01F 7/22; B01F 5/06; A23C 9/152; B01F 15/06

(52) U.S. Cl. CPC B01F 3/04453; B01F 7/225; B01F 5/0693; B01F 2015/062; B01F 15/065; B01F 2215/0006; A23C 9/1524

(57) ABSTRACT

A novel device for frothing milk and corresponding method are disclosed. The frothing device preferably comprises a rotatable shaft, an impeller rotatable by the shaft, and a screen disposed about the bottom of the impeller downstream of milk being pushed by the impeller. In another embodiment, the frothing device may further comprise a pitcher having a bottom wall, wherein the rotatable shaft extends upward from the bottom wall of the pitcher. This embodiment may further comprise a heater in the base of the pitcher. In yet another embodiment, the frothing device may further comprise a pitcher having a bottom wall, wherein the rotatable shaft extends upward from the bottom wall of the pitcher. This embodiment may further comprise a housing having a heater and a nub extending upwardly from the housing. The nub is configured to engage an opening at the bottom of the shaft for rotating the shaft. The disclosed embodiments advantageously create foam and further break the foam bubbles down into microscopic bubbles resulting in a silky smooth foam-textured milk without the conventional use of a steam wand or other such device.

### BACKGROUND

The present disclosure relates generally to a mechanism for preparing milk for espresso or cocoa-based drinks such as cappuccinos, cafe lattes, and mochas.

### SUMMARY

One exemplary embodiment of the disclosed subject matter is a frothing device preferably having a handle, a rotatable shaft coupled to the handle, an impeller rotatable by the shaft, and a screen disposed about the impeller opposite the handle. The frothing device may further include a holder disposed about the impeller and the screen. The screen is preferably annular in shape. The shaft may be integral to the impeller but preferably is coupled via a threaded arrangement.

In another exemplary embodiment, the frothing device includes a rotatable shaft, an impeller rotatable by the shaft, and a screen disposed about the bottom of the impeller downstream of the flow of fluid being pushed by the impeller. This frothing device may also have a handle coupled to the rotatable shaft. A holder may be disposed about the impeller and the screen.

In the alternative to the handle arrangement, the frothing device may include a pitcher having a bottom wall, wherein the rotatable shaft extends upward from the bottom wall of the pitcher. With this configuration, the impeller preferably includes a channel configured to receive the rotatable shaft. Moreover, the frothing device may include a housing having a heater and a nub extending upwardly from the housing. The shaft has an opening at its bottom, wherein the opening of the shaft is configured to receive the nub. A holder is preferably disposed about the impeller and the screen, wherein the screen has a hole configured to receive the impeller.

Another exemplary embodiment of the disclosed subject matter is a method of frothing comprising creating a vortex in milk using a frothing device, wherein the frothing device includes a rotatable shaft, an impeller rotatable by the shaft, and a screen disposed about the bottom of the impeller downstream of the flow of fluid being pushed by the impeller. The vortex is then stopped, either by moving the impeller away from the center or by slowing down the rotation of the impeller, wherein the milk is churned until microfoam is generated. The rotatable shaft may be coupled to a handle. In the alternative, the frothing device may include a pitcher, wherein the rotatable shaft is disposed about the bottom wall of the pitcher. The pitcher is disposed about the housing having a heater and a nub extending from the housing, wherein the rotatable shaft is configured to receive the nub. A holder may be disposed about the impeller and the screen.

### BRIEF DESCRIPTION OF THE DRAWINGS

Some non-limiting exemplary embodiments of the disclosed subject matter are illustrated in the following drawings. Identical or duplicate or equivalent or similar structures, elements, or parts that appear in one or more drawings are generally labeled with the same reference numeral, optionally with an additional letter or letters to distinguish between similar objects or variants of objects, and may not be repeatedly labeled and/or described. Dimensions of components and features shown in the figures are chosen for convenience or clarity of presentation. For convenience or clarity, some elements or structures are not shown or shown only partially and/or with different perspective or from different point of views.

FIG. 1 is a perspective view of an exemplary embodiment disclosed herein;

FIG. 2 is an exploded view of certain aspects of the embodiment shown in FIG. 1;

FIGS. 3A-3B are perspective views showing exemplary use of the embodiment seen in FIG. 1;

FIG. 4 is a perspective view of certain aspects of the embodiment shown in FIG. 1 in use;

FIGS. 5A-6B are perspective views of another exemplary embodiment disclosed herein;

FIG. 7A is an exploded view of certain aspects of the embodiment shown in FIGS. 5A-6B;

FIGS. 7B-7C are perspective views of certain aspects of the embodiment shown in FIGS. 5A-6B; and

FIGS. 8A-8B are perspective views of another exemplary embodiment disclosed herein.

### DETAILED DESCRIPTION

The preparation of quality silky textured milk for a cappuccino that allows a barista to create elegant patterns on the drink known as “latte art” is commonly seen in coffee shops. Such shops use large commercial espresso machines containing multiple water boilers, one of which is dedicated to creating scalding and high pressured steam. This steam is pushed through a steam wand at high velocity to heat the milk and create foam. A knowledgeable barista may further break down the bubbles in the foam to create even smaller bubbles, which may be referred to as microfoam. Microfoamed milk mixes with the espresso when being poured and adds a nice perceived sweetness to the final drink.

While it is possible for the home barista to create foam using an espresso machine having a steam boiler and wand, it is quite a different feat to create silky microfoam textured milk suitable for creating latte art. The typical home machine is just not as stout as the commercial machines found in coffee shops. Furthermore, many small home espresso machines do not include a second boiler or steam wand at all and only produce espresso, leaving the user unable to create any kind of microfoam milk. In an attempt to supplement these deficiencies, frothing devices have been designed for home use. Such devices usually employ a small whisk to create ordinarily sized bubbles, resulting in the milk almost immediately separating and having a thick foam texture on top with milk at the bottom. When poured, the milk will come out first followed by a blob of foam at the end. This foam blob does not mix well with the espresso drink, creates a separation of flavors with frothy milk on top and espresso on the bottom, and does not permit the desirable latte art.

Accordingly, a frothing device solving these and other problems is desired.

A general non-limiting overview of practicing the present disclosure is presented below. The overview outlines exemplary practice of embodiments of the present disclosure, providing a constructive basis for variant and/or alternative and/or divergent embodiments, some of which are subsequently described.

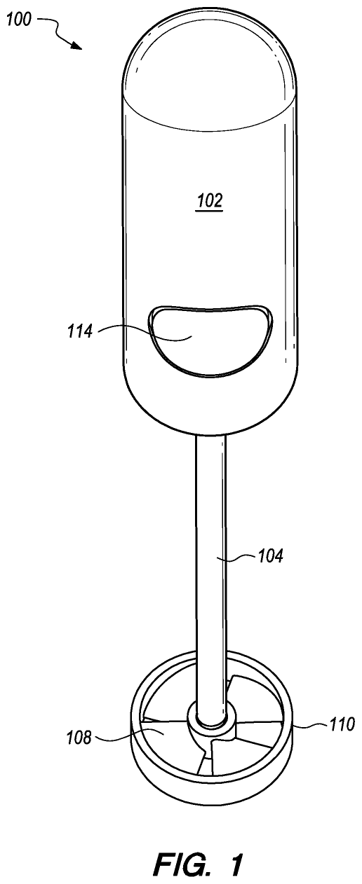

FIGS. 1-4 illustrate one such exemplary embodiment of novel frothing device 100 disclosed herein. As seen in FIG. 1, the device 100 preferably includes a handle 102 coupled to a rotatable shaft 104. The shaft 104 is in turn coupled to an impeller 106 having blades 108. The blades 108 may be of varying dimensions and shapes depending on the amount of thrust desired to be created, as discussed below.

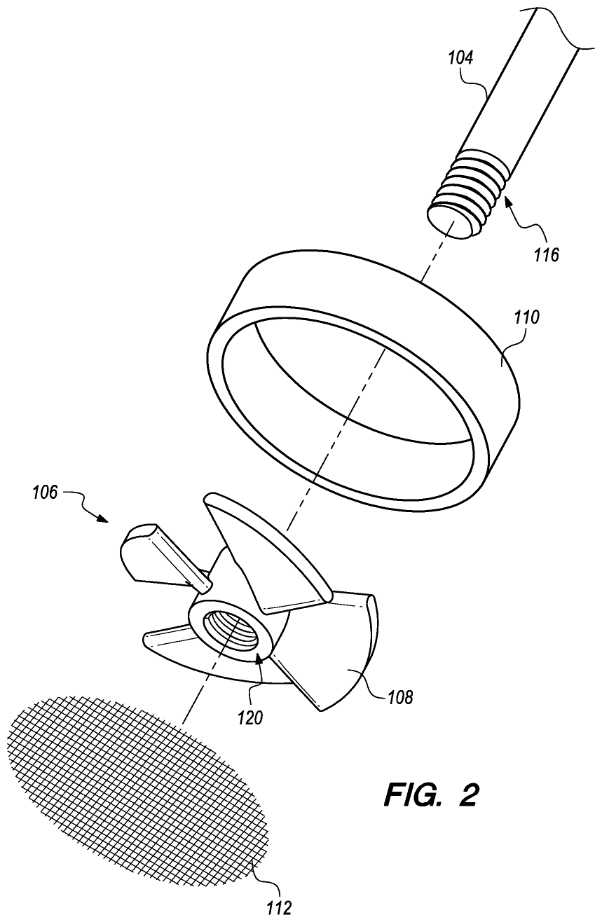

As best seen in FIG. 2, a mesh screen 112 is disposed about the impeller 106 opposite the shaft 104. The sizes of the holes within screen 112 may also be of varying dimensions and shapes depending on how large or fine the user desires the final bubble sizes to be in the resultant microfoam. The screen 112 may be coupled to the impeller 106 such as via welding, co-injecting, or some arrangement less permanent. Preferably, however, the screen 112 is disposed about the impeller 106 by way of a holder 110.

FIG. 2 illustrates the holder 110 may be annular in shape, wherein both the screen 112 and impeller 106 are constrained and held in place by holder 110 for added support and rigidity of the overall device 100.

FIG. 2 also illustrates the shaft 104 is preferably coupled to the impeller 106 via a thread and groove arrangement. In particular, shaft 104 may have threads 116 configured to engage grooves 120 cut into a channel of the impeller 106.

Turning back to FIG. 1, the frothing device 100 preferably includes a switch 114 in the handle 102. The switch 114 is in electrical communication with circuitry and a power supply such as one or more batteries. The switch 114 permits the device 100 to be powered on or off, and also preferably permits the shaft 104 to be rotated at varying speeds.

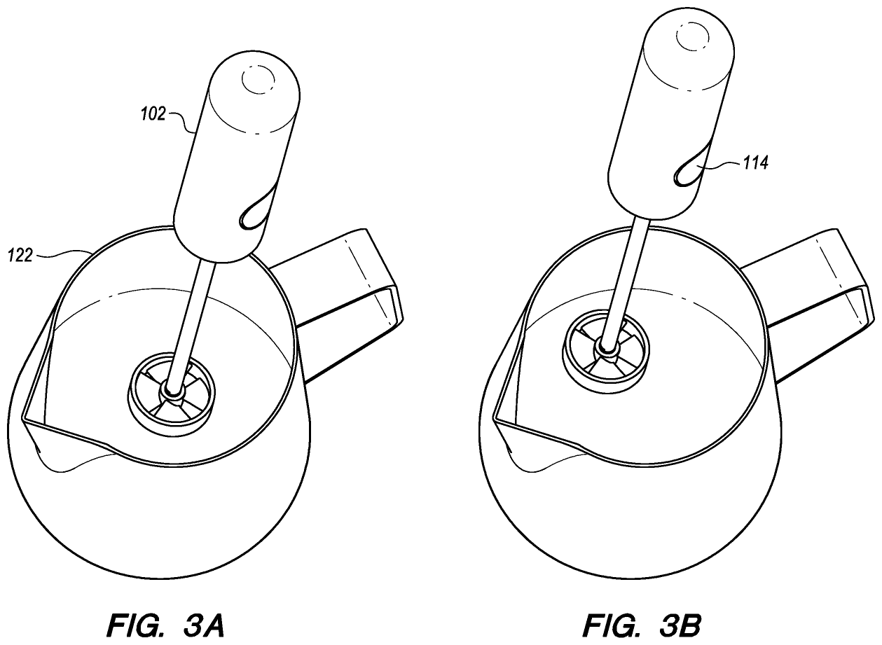

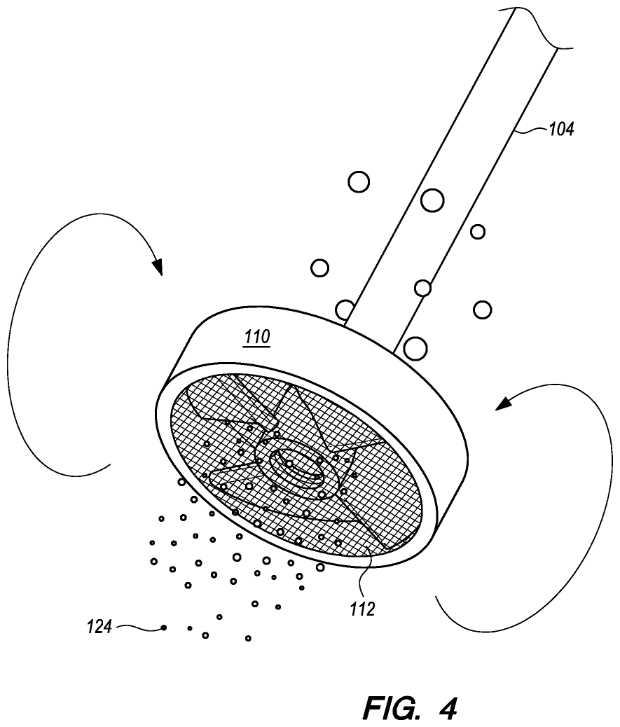

In operation, device 100 is operated by placing hot or cold milk into a pitcher 122 or container and submerging the impeller 106 and screen 112 into the milk near the center, as illustrated by FIG. 3A. The user may then toggle switch 114 to rotate shaft 104. Doing so will cause the impeller 106 and screen 112 to rotate rapidly inside the milk to create a vortex. The vortex in turn mixes ambient air with the milk to make bubbles and foam. When the device 100 is moved further off-center (as seen in FIG. 3B), the vortex ceases, and the impeller 106 becomes entirely submerged. No longer contacting ambient air and no longer producing new foam bubbles, the impeller 106 now only churns the milk and pulls the foam down where it is pushed through the impeller 106 and screen 112. The foam bubbles are thus broken down into microscopic bubbles 124 as they are forced through the screen 112 repeatedly, as best seen in FIG. 4. The result is a silky smooth microfoamed milk for pouring over espresso or the like and creating latte art if desired.

Thus, it is the particular configuration of the screen 112 disposed below the impeller 106, i.e., downstream of the flow, that creates the microfoam rather than the use of steam or a whisk. Moreover, it is worth noting that such a configuration is counter-intuitive and/or opposite to what may be thought of as a conventional filter and impeller arrangement. In other words, screens or filters would typically be disposed above the impeller, i.e., upstream of the flow, to filter out unwanted material from passing into the impeller and thus irreparably damaging it. However, with the disclosed embodiments, the screen 112 is downstream of the flow—not for the purpose of filtering out any undesirable material—but rather for breaking down bubbles in the flow to create the desirable microfoam.

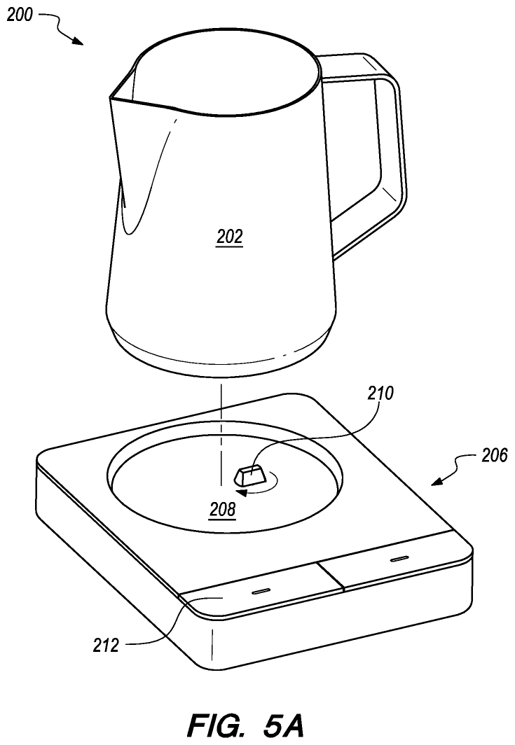

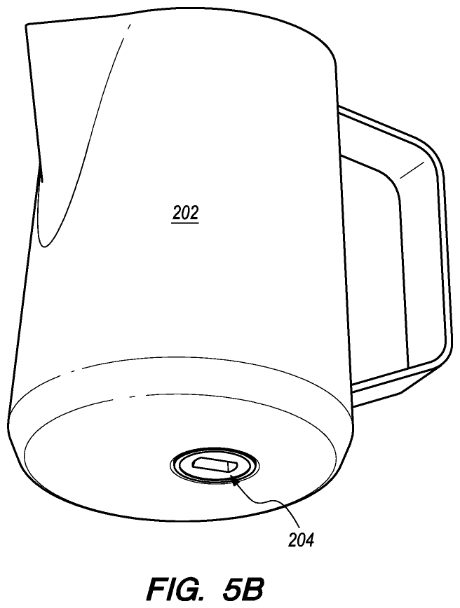

FIGS. 5A-7C illustrate another embodiment of the disclosed subject matter. As seen therein, the frothing device 200 preferably comprises a pitcher 202 disposed about a housing 206. The pitcher 202 includes a rotatable shaft 204 disposed about the bottom wall of the pitcher 202, as best seen in FIG. 5B. The shaft 204 includes a channel configured to receive a rotatable nub 210 disposed about the top wall of the housing 206.

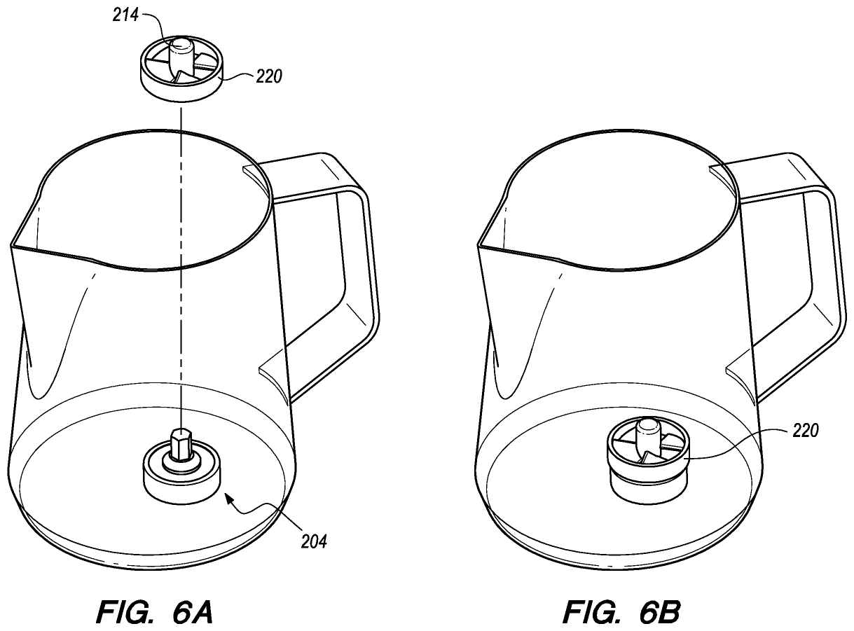

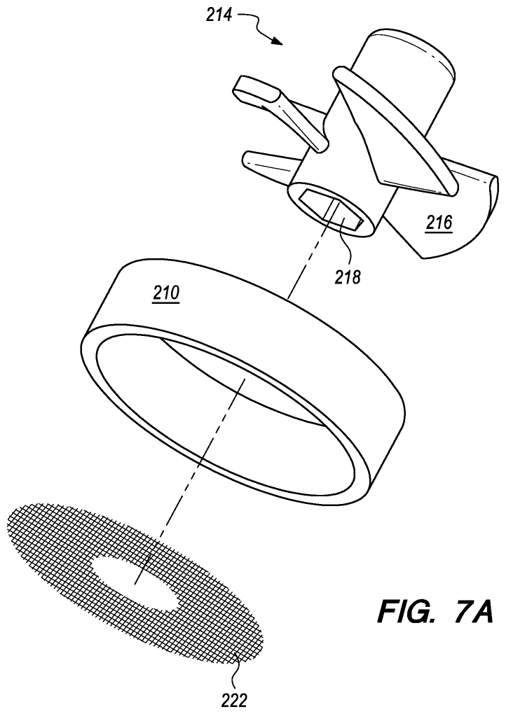

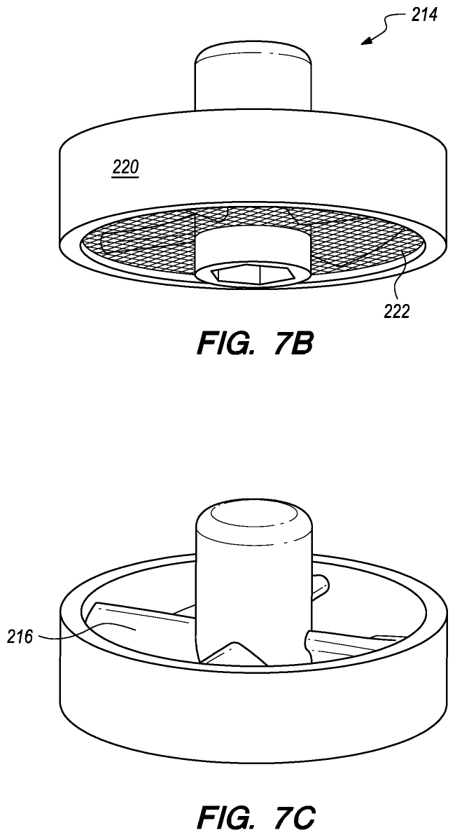

The device 200 further includes an impeller 214 having blades 216 of varying dimensions and shapes depending on user preference, as discussed above in the context of FIGS. 1-4. The impeller 214 is configured to engage the rotatable shaft 204, as illustrated in FIGS. 6A-6B. FIG. 7A illustrates an exploded view of an exemplary engagement obtained by a channel 218 cut into the impeller 214 for receiving the rotatable shaft 204. Instead of this configuration, the device 200 may use a magnetic spinning arrangement to turn the impeller 214.

FIG. 7A also shows the use of a screen 222 disposed about the impeller 214 in a downstream arrangement as discussed above. Stated differently, the impeller 214 is rotatable by the shaft 204, wherein the impeller 214 has a top and an opposing bottom. The impeller 214 is configured to move fluid from the top to the bottom of the impeller 214, wherein the screen 222 is disposed about the bottom of the impeller 214.

The screen 222 may be permanently attached to impeller 214 or removable as discussed above. Moreover, an optional holder 210 may partially encapsulate the impeller 214 and screen 222, the latter of which preferably has a cut-out centrally located therein to receive the bottom portion of the rotatable impeller 214, as best seen in FIGS. 7A-7C.

Referring again to FIG. 5A, the housing 206 preferably includes a heater 208 for heating milk in pitcher 202. Switches 212 are disposed about the housing 206. The switches 212 are in electrical communication with a power supply such one or more batteries. The switches 212 may be engaged by the user to turn on device 200, causing heater 208 to heat up and rotating shaft 204 to spin impeller 214. The user may use the switches 212 to vary the speed of the impeller and thus the speed at which milk flows from the top of the pitcher 202, through the blades 216, and then the screen 222 downstream of the flow. Doing so permits the user to create a vortex and aerate the milk or to churn and create microfoam.

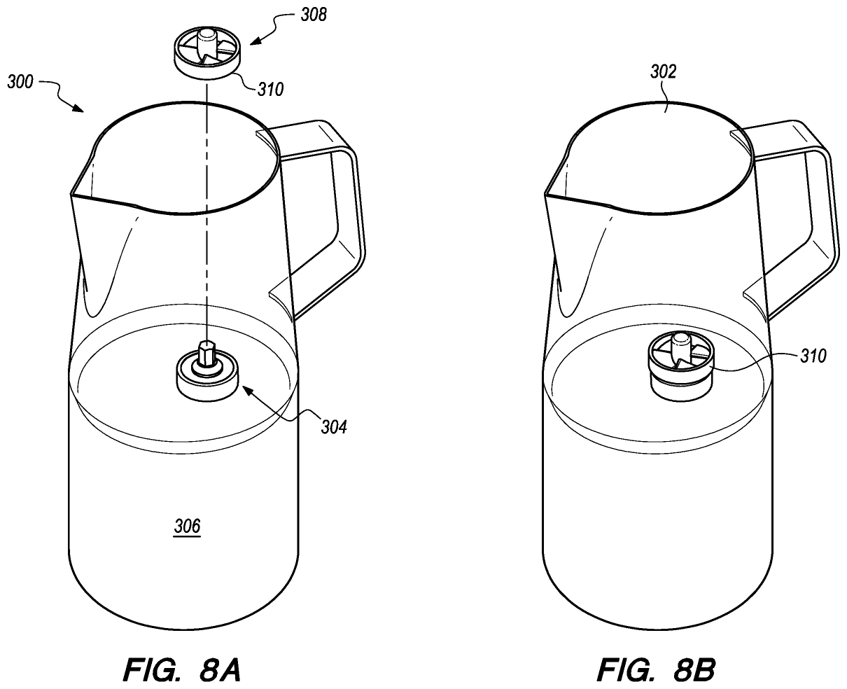

FIGS. 8A-8B illustrate another embodiment of the disclosed subject matter. Here, the frothing device 300 may include a pitcher 302 containing a waterproof rotatable shaft 304 disposed about the bottom of the pitcher 302. An impeller 308, screen, and holder 310 arrangement similar to that illustrated in FIGS. 5A-7C may be connected to this shaft 304 from inside the pitcher 302. Doing so positions the impeller 308 and screen component near the bottom of the pitcher 302 and preferably slightly off-center. The device 300 also preferably includes a housing 306 having a hot plate with a motorized rotating nub. The nub is positioned to couple with the shaft 304 when the pitcher 302 is placed on the hot plate. When turned on, the hot plate heats the pitcher 302 to warm the milk and rotate the nub and blend the milk. Accelerating the impeller 308 and screen sufficiently will create a vortex in the milk while decelerating will stop the vortex and churn the milk to create the desired microfoam, as discussed above.

While certain embodiments have been described, the embodiments have been presented by way of example only and are not intended to limit the scope of the inventions. Indeed, the novel frothing device and corresponding method described herein may be embodied in a variety of other forms. Furthermore, various omissions, substitutions, and changes in the form of the disclosed elements may be made without departing from the spirit of the inventions. The accompanying claims and their equivalents are intended to cover such forms or modifications as would fall within the scope and spirit of the inventions.

1. A frothing device comprising:
a handle;
a rotatable shaft coupled to the handle;
an impeller rotatable by the shaft; and
a screen disposed about the impeller opposite the handle.

2. The frothing device of claim 1, further comprising a holder disposed about the impeller and the screen.

3. The frothing device of claim 2, wherein the screen is annular.

4. The frothing device of claim 1, wherein the shaft is integral to the impeller.

5. A frothing device comprising:
a rotatable shaft;
an impeller rotatable by the shaft, wherein the impeller has a top and an opposing bottom, wherein the impeller is configured to move fluid from the top to the bottom of the impeller; and
a screen disposed about the bottom of the impeller.

6. The frothing device of claim 5, further comprising a holder disposed about the impeller and the screen.

7. The frothing device of claim 5, further comprising a pitcher having a bottom wall, wherein the rotatable shaft extends upward from the bottom wall of the pitcher.

8. The frothing device of claim 7, wherein the impeller includes a channel configured to receive the rotatable shaft.

9. The frothing device of claim 8, further comprising a housing having a heater and a nub extending upwardly from the housing, wherein the shaft has a top and an opposing bottom, wherein the shaft has an opening at its bottom, wherein the opening of the shaft is configured to receive the nub.

10. The frothing device of claim 9, further comprising a holder disposed about the impeller and the screen, wherein the screen has a hole configured to receive the impeller.

11. A method of frothing comprising:
creating a vortex in milk using a frothing device, wherein the frothing device includes a rotatable shaft, an impeller rotatable by the shaft, wherein the impeller has a top and an opposing bottom, and wherein the impeller is configured to move milk from the top to the bottom of the impeller, and a screen disposed about the bottom of the impeller;
stopping the vortex; and
churning the milk until microfoam is generated.

12. The method of claim 11, wherein the rotatable shaft is coupled to a handle.

13. The method of claim 11, further comprising a pitcher having a bottom wall, wherein the rotatable shaft is disposed about the bottom wall of the pitcher.

14. The method of claim 13, further comprising a housing having a heater and a nub extending from the housing, wherein the rotatable shaft is configured to receive the nub.

15. The method of claim 14, further comprising a holder disposed about the impeller and the screen.
